(19) United States
(12) Patent Application Publication
(10) Pub. No.: US 2024/0362799 A1
(43) Pub. Date: Oct. 31, 2024

(54) HUMAN BODY MOTION CAPTURE METHOD AND APPARATUS, DEVICE, MEDIUM, AND PROGRAM

(71) Applicant: Beijing Zitiao Network Technology Co., Ltd., Beijing (CN)

(72) Inventors: Zeyi LIN, Beijing (CN); Yang ZHANG, Beijing (CN); Zhen FAN, Beijing (CN)

(21) Appl. No.: 18/640,845

(22) Filed: Apr. 19, 2024

(30) Foreign Application Priority Data
Apr. 26, 2023 (CN) 202310465797.1

(51) Int. Cl. G06T 7/246; G06F 3/01; G06T 7/73

(52) U.S. Cl. CPC G06T 7/246; G06T 7/74; G06F 3/012; G06T 2207/20081; G06T 2207/20084; G06T 2207/30196

(57) ABSTRACT

A human body motion capture method and apparatus, a device, a medium, and a program are provided. Pose information of a headset is obtained. A human body image shot by the headset is obtained. Motion information of a key node of a human body is determined based on the human body image, and the motion information of the key node includes position information or pose information of the key node. Motion information of a head is determined based on the pose information of the headset, and the motion information of the head includes position information or pose information of the head. Posture information of the human body is determined by using an inverse kinematics method based on the motion information of the key node and the motion information of the head.

### CROSS-REFERENCE TO RELATED APPLICATION

The present application claims priority of the Chinese Patent Application No. 202310465797.1, filed on Apr. 26, 2023, the disclosure of which is incorporated herein by reference in the present application.

### TECHNICAL FIELD

Embodiments of the present application relate to the field of human body motion capture technologies, and in particular, to a human body motion capture method and apparatus, a device, a medium, and a program.

### BACKGROUND

Human body motion capture technology is a technology through which posture information and a motion trajectory of a human body in a three-dimensional space can be detected and human motion can be reproduced in a virtual three-dimensional environment. Human body motion capture technology is widely used in the fields of film-making, motion analysis, game production, medical diagnosis, and the like.

In a current human body motion capture method, inertial data acquired by an inertial measurement unit (IMU) is mainly used. For example, in a virtual reality (VR) scenario, a user needs to wear wearable devices integrated with IMUs on a wrist, an ankle, and the like, and a headset estimates human body posture information based on IMU data obtained by the headset and IMU data sent by the wearable devices worn on the wrist, the ankle, and the like.

However, wearing the wearable devices on the wrist, the ankle, and the like of the human body brings the user a sense of restraint, which reduces user experience.

### SUMMARY

Embodiments of the present application provide a human body motion capture method and apparatus, a device, a medium, and a program. Motion information of a key node of a human body is determined based on a human body image shot by a headset, which can obviate the need for a wearable device that assists in detecting the motion information of the key node of the human body to be worn on the key node of the human body, thereby improving user experience.

According to a first aspect, an embodiment of the present application provides a human body motion capture method. The method includes:
obtaining pose information of a headset;
obtaining a human body image shot by the headset;
determining motion information of a key node of a human body based on the human body image, the motion information of the key node including position information or pose information of the key node, and the key node including one or more of a hand key node, a foot key node, or a waist key node;
determining motion information of a head based on the pose information of the headset, the motion information of the head including position information or pose information of the head; and
determining, by using an inverse kinematics method, posture information of the human body based on the motion information of the key node and the motion information of the head.

In some embodiments, the determining motion information of a key node of a human body based on the human body image includes:
inputting the human body image to a deep learning network to obtain the motion information of the key node of the human body.

In some embodiments, the deep learning network includes a first deep learning subnetwork and a second deep learning subnetwork; and
the inputting the human body image to a deep learning network to obtain the motion information of the key node of the human body includes:
inputting the human body image to the first deep learning subnetwork to obtain motion information of the hand key node; and
inputting the human body image to the second deep learning subnetwork to obtain motion information of the foot key node.

In some embodiments, the second deep learning subnetwork further outputs motion information of the waist key node.

In some embodiments, the deep learning network further includes a third deep learning subnetwork; and the method further includes:
inputting the human body image to the third deep learning subnetwork to obtain motion information of the waist key node.

In some embodiments, when the motion information of the key node includes the position information of the key node, and the motion information of the head includes the position information of the head, the determining, by using an inverse kinematics method, posture information of the human body based on the motion information of the key node and the motion information of the head includes:
determining, by using the inverse kinematics method, posture information of the key node and posture information of the head based on the position information of the key node and the position information of the head; and
determining posture information of another node of the human body based on the posture information of the key node and the posture information of the head.

In some embodiments, the method further includes:
training the deep learning network with a human body sample image, a label of the human body sample image being actual motion information of the key node, and the actual motion information of the key node including actual position information or actual pose information of the key node;
computing a loss of the deep learning network based on the label of the human body sample image and estimated motion information output by the deep learning network; and
updating a parameter of the deep learning network based on the loss of the deep learning network.

In some embodiments, the computing a loss of the deep learning network based on the label of the human body sample image and estimated position information output by the deep learning network includes:
when the key node is visible in the human body sample image, computing the loss of the deep learning network based on the label of the human body sample image and the estimated motion information output by the deep learning network.

In some embodiments, the method further includes:
determining a confidence of the key node based on the human body sample image; and
determining, based on the confidence of the key node, whether the key node is visible.

In some embodiments, the motion information of the foot key node is motion information of an ankle of the human body, and/or the motion information of the hand key node is motion information of a wrist of the human body.

In some embodiments, the headset obtains the pose information of the headset by using a visual simultaneous localization and mapping (SLAM) method.

According to another aspect, an embodiment of the present application provides a human body motion capture apparatus. The apparatus includes:
a first obtaining module configured to obtain pose information of a headset;
a second obtaining module configured to obtain a human body image shot by the headset;
a first position determining module configured to determine motion information of a key node of a human body based on the human body image, the motion information of the key node including position information or pose information of the key node, and the key node including one or more of a hand key node, a foot key node, or a waist key node;
a second position determining module configured to determine motion information of a head based on the pose information of the headset, the motion information of the head including position information or pose information of the head; and
a posture estimation module configured to determine, by using an inverse kinematics method, posture information of the human body based on the motion information of the key node and the motion information of the head.

According to another aspect, an embodiment of the present application provides an electronic device. The electronic device includes a processor and a memory. The memory is configured to store a computer program. The processor is configured to invoke and run the computer program stored in the memory, to perform the method described in any one of the embodiments.

According to another aspect, an embodiment of the present application provides a computer-readable storage medium. The computer-readable storage medium stores a computer program. The computer program causes a computer to perform the method described in any one of the embodiments.

According to another aspect, an embodiment of the present application provides a computer program product, including a computer program. When the computer program is executed by a processor, the method described in any one of the embodiments is implemented.

According to the human body motion capture method and apparatus, the device, the medium, and the program provided in the embodiments of the present application, the pose information of the headset is obtained. The human body image shot by the headset is obtained. The motion information of the key node of the human body is determined based on the human body image, the motion information of the key node including the position information or the pose information of the key node, and the key node including one or more of the hand key node, the foot key node, or the waist key node. The motion information of the head is determined based on the pose information of the headset, the motion information of the head including the position information or the pose information of the head. The posture information of the human body is determined by using the inverse kinematics method based on the motion information of the key node and the motion information of the head. According to the method, the motion information of the key node of the human body is determined based on the human body image shot by the headset, which can obviate the need for a wearable device that assists in detecting the motion information of the key node of the human body to be worn on the key node of the human body, thereby improving user experience.

### BRIEF DESCRIPTION OF DRAWINGS

To illustrate the technical solutions of the embodiments of the present disclosure more clearly, the accompanying drawings for describing the embodiments are briefly described below. Apparently, the accompanying drawings in the following description illustrate merely some embodiments of the present disclosure, and a person of ordinary skill in the art may derive other drawings from these accompanying drawings without creative efforts.

FIG. 1 is a flowchart of a human body motion capture method according to Embodiment 1 of the present application;

FIG. 2 is a schematic diagram of a principle of a human body motion capture method according to Embodiment 2 of the present application;

FIG. 3 is a schematic flowchart of a human body motion capture method according to Embodiment 2 of the present application;

FIG. 4 is a schematic diagram of a structure of a human body motion capture apparatus according to Embodiment 3 of the present application; and

FIG. 5 is a schematic diagram of a structure of an electronic device according to Embodiment 4 of the present application.

### DETAILED DESCRIPTION

The technical solutions in the embodiments of the present disclosure are clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the scope of protection of the present disclosure.

It should be noted that the terms “first”, “second”, and the like in the description, claims, and drawings of the present disclosure are intended to distinguish between similar objects but do not necessarily describe a specific order or sequence. It should be understood that the data termed in such a way is interchangeable in proper circumstances, so that the embodiments of the present disclosure described herein can be implemented in other orders than those illustrated or described herein. In addition, the terms “include” and “have” and any variants thereof are intended to cover a non-exclusive inclusion. For example, a process, method, system, product, or server that includes a list of steps or units is not necessarily limited to those expressly listed steps or units, but may include other steps or units not expressly listed or inherent to such a process, method, product, or device.

An embodiment of the present application provides a human body motion capture method, which may be applied to a head-mounted extended reality (XR) device. The head-mounted XR device is also referred to as a headset.

Extended reality (XR) refers to combining reality with virtuality through a computer to create a virtual environment that allows for human-computer interaction. XR is also an umbrella term for a plurality of technologies such as virtual reality (VR), augmented reality (AR), and mixed reality (MR). Fusion of these three visual interaction technologies makes an experiencer “immersive” in seamless switching between a virtual world and a physical world. The head-mounted XR device includes but is not limited to a head-mounted VR device, AR device, and MR device.

VR: It is a technology that allows for the creation and experience of a virtual world. It generates a virtual environment through computation, and is a simulation of an interactive three-dimensional dynamic visual scene and an entity behavior based on fusion of multi-source information (virtual reality mentioned herein includes at least visual perception, may further include auditory perception, tactile perception, and motion perception, and even includes gustatory perception, olfactory perception, and the like), immersing a user in a simulated virtual reality environment, and realizing applications in a plurality of virtual environments such as maps, games, videos, education, medical care, simulation, collaborative training, sales, assisted manufacturing, maintenance, and repair.

A VR device is a terminal that achieves virtual reality effects, and may be generally provided in the form of glasses, a head-mounted display (HMD), or contact lenses, to implement visual perception and other forms of perception. Certainly, the virtual reality device is not limited to these implementation forms, and may be further miniaturized or enlarged as needed.

AR: An AR setting is a simulated setting with at least one virtual object superimposed on a physical setting or a representation thereof. For example, an electronic system may have an opaque display and at least one imaging sensor. The imaging sensor is configured to capture an image or a video of the physical setting. The image or the video is a representation of the physical setting. The system combines the image or the video with the virtual object, and displays the combination on the opaque display. An individual uses the system to view the physical setting indirectly via the image or the video of the physical setting, and observes the virtual object superimposed on the physical setting. When the system captures images of the physical setting by using one or more image sensors, and presents the AR setting on the opaque display by using the images, the displayed images are called a video transparent transmission. Alternatively, the electronic system configured to display the AR setting may have a transparent or semi-transparent display, and an individual may view the physical setting directly through the display. The system may display the virtual object on the transparent or semi-transparent display, so that the individual uses the system to observe the virtual object superimposed on the physical setting. For another example, the system may include a projection system for projecting the virtual object into the physical setting. The virtual object may be projected, for example, on a physical surface or as a hologram, so that an individual uses the system to observe the virtual object superimposed on the physical setting. Specifically, AR is a technology for computing, in real time in a process in which a camera acquires the image, a camera posture information parameter of the camera in the physical world (or referred to as a three-dimensional world or a real world) and adding, based on the camera posture information parameter, a virtual element on the image acquired by the camera. The virtual element includes but is not limited to an image, a video, and a three-dimensional model. An objective of the AR technology is to connect the virtual world to the physical world for interaction.

MR: Virtual scene information is presented in a physical scene to build up an information loop for interactive feedback between the physical world, the virtual world, and a user, to enhance the sense of reality in user experience. For example, a sensory input (for example, a virtual object) created by a computer and a sensory input from the physical setting or a representation thereof are integrated in a simulated setting. In some MR settings, the sensory input created by the computer may adapt to changes in the sensory input from the physical setting. In addition, some electronic systems configured to present an MR setting may monitor orientation and/or position information relative to the physical setting, so that the virtual object can interact with a real object (that is, a physical element from the physical setting or a representation thereof). For example, the system may monitor motion, so that a virtual plant looks still relative to a physical building.

Optionally, an XR device described in the embodiments of the present application is also referred to as a virtual reality device, including, but not limited to, the following several types:
(1) Mobile virtual reality device: It supports setting of a mobile terminal (for example, a smartphone) in various manners (for example, a head-mounted display provided with a special slot), and is connected to the mobile terminal in a wired or wireless manner. The mobile terminal performs computation related to a virtual reality function, and outputs data to the mobile virtual reality device. For example, a virtual reality video is watched through an app of the mobile terminal.
(2) Integrated virtual reality device: It has a processor configured to perform computation related to a virtual function, and therefore has an independent virtual reality input and output function, with no need to be connected to a PC or a mobile terminal, providing a high degree of freedom of use.
(3) Personal computer virtual reality (PCVR) device: It performs computation related to a virtual reality function and data output by using a PC. An external personal computer virtual reality device achieves virtual reality effects by using data output by the PC.

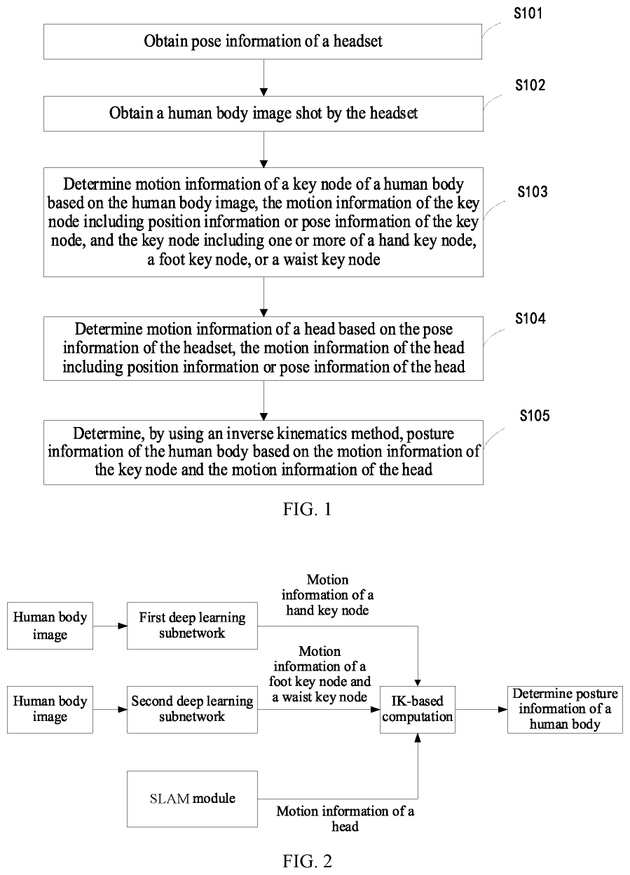

FIG. 1 is a flowchart of a human body motion capture method according to Embodiment 1 of the present application. The method in this embodiment is performed by an XR device. When the XR device is an integrated machine, the XR device is a headset; or when the XR device is not an integrated machine, the XR device includes a headset and a terminal device (for example, a mobile phone or a computer) connected to the headset. As shown in FIG. 1, the human body motion capture method includes the following steps.
S101: Obtain pose information of the headset.

The pose information of the headset includes position information and posture information of the headset. A localization module in the headset is configured to locate the pose information of the headset.

Optionally, the localization module obtains the pose information of the headset by using a visual simultaneous localization and mapping (SLAM) method. The localization module is also referred to as a SLAM module. For example, the SLAM module may perform localization based on an image acquired by a camera of the headset and inertial data acquired by an inertial measurement unit (IMU). The IMU is integrated in the headset. The IMU is a common inertial sensor. The IMU measures the inertial data. The inertial data may include a triaxial posture information angle and a triaxial acceleration.
S102: Obtain a human body image shot by the headset.

The human body image is an image of a human body wearing the headset. The human body image is an image including all or part of the human body. One or more cameras are mounted on the headset. The human body image is shot through the camera.

For example, six cameras are mounted on a common headset. The six cameras are mounted at different positions and at different angles. Different cameras shoot different images. Therefore, the human body image shot by the headset may include a plurality of human body images, from different perspectives, shot at a same moment.
S103: Determine motion information of a key node of the human body based on the human body image, the motion information of the key node including position information or pose information of the key node, and the key node including one or more of a hand key node, a foot key node, or a waist key node.

The motion information of the key node of the human body includes the position information or the pose information of the key node. The pose information includes position information or posture information. The position information of the key node is three-dimensional coordinates of the key node, that is, xyz coordinates of the key node. The three-dimensional coordinates may be coordinates under a world coordinate system. The posture information of the key node is a rotation angle of the key node on xyz coordinate axes.

Position information of the hand key node may be position information of a wrist or position information of a palm. Position information of the foot key node may be position information of an ankle or position information of toes. The waist key node may be used as a root node of the human body, which is a hypothetic node located in the pelvis, and is used to represent position information of the human body in the world coordinate system. The hand key node of the human body may include one hand key node or two hand (that is, left and right hand) key nodes. Similarly, the foot key node of the human body may include one foot key node or two foot (that is, left and right foot) key nodes.

The XR device may determine motion information of each key node based on one human body image, or may determine motion information of each key node based on the plurality of human body images, from different perspectives, shot at the same moment.

In an implementation, the motion information of the key node of the human body is estimated through a neural network. The neural network may be a deep learning network. The human body image is input to the deep learning network to obtain the motion information of the key node of the human body.

Deep learning is a type of machine learning. Deep learning combines low-level features into more abstract high-level representation attributes, categories, or features, to discover a distributed feature representation of data. The motivation of deep learning lies in establishing a neural network that simulates a human brain to perform analytic learning. The neural network mimics a mechanism of the human brain to interpret data, for example, images, sounds, and text.

The deep learning network may be a convolutional neural network (CNN), or may be a deep brief network (DBN) or the like.

Optionally, the deep learning network includes a plurality of subnetworks. Motion information of different key nodes is estimated through different deep learning networks. For example, the deep learning network includes a first deep learning subnetwork and a second deep learning subnetwork. The first deep learning subnetwork is configured to estimate the motion information of the hand key node. The second deep learning subnetwork is configured to estimate the motion information of the foot key node.

Optionally, the second deep learning network is further configured to estimate motion information of the waist key node. Alternatively, the deep learning network further includes a third deep learning subnetwork configured to estimate motion information of the waist key node.

In another implementation, a depth map of the human body image and camera pose information corresponding to the human body image are obtained, and three-dimensional coordinates of each pixel of the human body image may be determined based on the depth map of the human body image and the camera pose information, so that three-dimensional coordinates of each key node can be obtained. The camera pose information includes a rotation matrix and a translation matrix of the camera relative to the world coordinate system when the human body image is shot.
S104: Determine motion information of a head based on the pose information of the headset, the motion information of the head including position information or pose information of the head.

The pose information of the headset or the position information in the pose information may be used as the motion information of the head of the human body. Alternatively, a specific offset is performed on the pose information of the headset or the position information in the pose information, to obtain the motion information of the head of the human body. For example, the specific offset is added to the pose information of the headset to obtain the pose information of the head of the human body.
S105: Determine, by using an inverse kinematics method, posture information of the human body based on the motion information of the key node and the motion information of the head.

In a VR or AR application, posture information of a joint point of the human body needs to be used to drive an animated character to move. The posture information of the human body is posture information of each joint point of the human body. The posture information of the joint point is a rotation angle of the joint point. In different applications, different human body models may be defined, and different models may have different joint points. For example, a human body model includes a head node, a left shoulder joint, a right shoulder joint, a left elbow node, a right elbow node, a left wrist node, a right wrist node, a waist node, a left hip node, a right hip node, a left knee node, a right knee node, a left ankle node, and the like. The left hip node and the right hip node may also be understood as a left hip joint and a right hip joint.

In this embodiment, the posture information of the human body estimated by using the inverse kinematics (IK for short) method includes at least the posture information of the key node and the posture information of the head, and certainly, may further include posture information of another node.

In interactive VR and AR applications, a movement of a character may be determined with the aid of an IK algorithm. The IK algorithm is a method in which position information of a child bone is first determined and then position information of n levels of parent bones on a chain of bones on which the child bone is located is reversely derived, to determine the entire chain of bones. A principle of the IK algorithm is driving a parent node to move and rotate by changing position information and a rotation angle of a child node. The IK algorithm considers human kinematic constraints when computing the posture information of the human body.

When the motion information of the key node includes the position information of the key node, and the motion information of the head includes the position information of the head, the posture information of the key node and the posture information of the head may be determined by using the inverse kinematics method based on the position information of the key node and the position information of the head, and posture information of another node of the human body may be determined based on the posture information of the key node and the posture information of the head.

When the motion information of the key node includes the pose information of the key node, and the motion information of the head includes the pose information of the head, posture information of another node of the human body may be determined by using the inverse kinematics method based on the posture information of the key node and the posture information of the head.

When the motion information of the key node includes the position information of the key node, and the motion information of the head includes the pose information of the head, the posture information of the key node may be determined by using the inverse kinematics method based on the position information of the key node and the pose information of the head, and posture information of another node of the human body may be determined based on the posture information of the key node and the posture information of the head.

For example, posture information of the two hand key nodes, the two foot key nodes, and the head is first computed by using the IK algorithm based on position information of the two hand key nodes, position information of the two foot key nodes, and the position information of the head, and then the posture information of the another node of the human body is determined based on the computed posture information of the nodes. According to the IK algorithm, starting from an end node, posture information of connected upper-level nodes is sequentially determined until posture information of all nodes is determined.

The two hand key nodes and the two foot key nodes are used as an example. The two hand key nodes and the two foot key nodes are all end nodes. An upper-level node connected to the hand key node is an elbow joint. An upper-level node of the elbow joint is a shoulder joint. An upper-level node connected to the foot key node is a knee joint. An upper-level node of the knee joint is a hip joint. Therefore, posture information of the elbow joint may be determined based on the posture information of the hand key node, and posture information of the shoulder joint may be determined based on the posture information of the elbow joint. Similarly, posture information of the knee joint may be determined based on the posture information of the foot key node, and posture information of the hip joint may be determined based on the posture information of the knee joint.

It may be understood that when posture information of an upper-level node of a node is determined, kinematic constraints between the nodes need to be considered. In general, joint points of the elbow joint and the knee joint are assumed as hinge joints, that is, they can rotate only in a fixed plane. For example, for the elbow joint, a plane formed by the shoulder joint, the elbow joint, and a wrist joint is a rotation plane. All other nodes than the hinge joint points may be rotated freely.

It should be noted that if the motion information of the head includes the posture information of the head, the posture information of the head does not need to be computed according to the IK algorithm; or if the motion information of the head does not include the posture information of the head, the posture information of the head needs to be computed according to the IK algorithm.

In a conventional technology, for the motion information of the hand key node, the foot key node, and the waist key node, additional wearable devices usually need to be worn on the corresponding key nodes to assist in detecting the motion information of the key nodes. According to the method in this embodiment, a user does not need to wear the wearable device on the key node of the human body, thereby improving user experience. The method in this embodiment is a purely visual human body motion capture method. The motion information of the key node of the human body is determined based on the human body image shot by the camera of the headset, which can free hands of the user, thereby improving user experience. In addition, the purely visual solution is more consistent with naturalness of human-computer interaction.

In addition, in this embodiment, if more key nodes are used, the estimated posture information of the human body is more accurate. For example, estimating the posture information of the human body based on motion information of at least five key nodes (the head, the two hand key nodes, and the two foot key nodes) of the human body can ensure accuracy of the estimated posture information of the human body. For driving a virtual character in an AR or VR game, a posture of the virtual character may be generally well determined based on position information of five nodes, namely, the head, two wrists, and two feet. If fewer nodes are used to estimate the posture information of the human body, the estimated posture information of the human body is not so accurate.

It may be understood that if more key nodes are used, the estimated posture information of the human body is more accurate. However, excessive nodes may increase a computational amount for estimating the motion information of the key node and a computational amount of the IK algorithm, bringing an increase of computing resources and latency. Given a requirement of an XR application scenario for real-time performance, both the latency and accuracy need to be considered when the key node is selected.

After the posture information of each joint point of the human body is obtained, 6-degrees-of-freedom (DoF) data of each joint point of the human body is obtained based on position information and posture information of each joint point. The 6DoF data of the joint point includes 3DoF rotation data and 3DoF movement data. The rotation data may be understood as a rotation angle of the joint. The movement data may be understood as a translation amount of the joint point on XYZ axes.

The position information of each joint point of the human body is estimated based on the position information of the key node of the human body and the position information of the head that are determined in S102 and S103.

In this embodiment, the pose information of the headset is obtained. The human body image shot by the headset is obtained. The motion information of the key node of the human body is determined based on the human body image, the motion information of the key node including the position information or the pose information of the key node, and the key node including one or more of the hand key node, the foot key node, or the waist key node. The motion information of the head is determined based on the pose information of the headset, the motion information of the head including the position information or the pose information of the head. The posture information of the human body is determined by using the inverse kinematics method based on the motion information of the key node and the motion information of the head. According to the method, the motion information of the key node of the human body is determined based on the human body image shot by the headset, which can obviate the need for a wearable device that assists in detecting the motion information of the key node of the human body to be worn on the key node of the human body, thereby improving user experience.

Based on Embodiment 1, Embodiment 2 of the present application provides a human body motion capture method. In this embodiment, the deep learning network is used to determine the motion information of the key node of the human body. In this embodiment, an example in which the deep learning network includes the first deep learning subnetwork and the second deep learning subnetwork is used for description.

FIG. 2 is a schematic diagram of a principle of the human body motion capture method according to Embodiment 2 of the present application. As shown in FIG. 2, human body images are input to the first deep learning subnetwork and the second deep learning subnetwork. The human body images input to the first deep learning subnetwork and the second deep learning subnetwork may be the same or different. When the human body images input to the first deep learning subnetwork and the second deep learning subnetwork are different, the human body images input to the first deep learning subnetwork and the second deep learning subnetwork are human body images, from different perspectives, shot by different cameras of the headset at a same moment.

For example, the headset includes two cameras mounted at different positions and at different angles, where one camera is configured to shoot a hand image of the human body, and the other camera is configured to shoot a lower half image of the human body. The human body image input to the first deep learning subnetwork is also referred to as the hand image. The human body image input to the second deep learning subnetwork is also referred to as the lower half image.

The human body image is input to the first deep learning subnetwork, and an output of the first deep learning subnetwork is the motion information of the hand key node. The human body image is input to the second deep learning subnetwork, and an output of the second deep learning subnetwork is the motion information of the foot key node and the waist key node. The SLAM module of the headset outputs the motion information of the head to an IK-based computation module. The IK-based computation module computes the posture information of the head, the two hand key nodes, the two foot key nodes, the waist joint node, and the another node of the human body based on the motion information of the head output by the SLAM module, the motion information of the hand key node output by the first deep learning subnetwork, and the motion information of the foot key node and the motion information of the waist key node that are output by the second deep learning subnetwork.

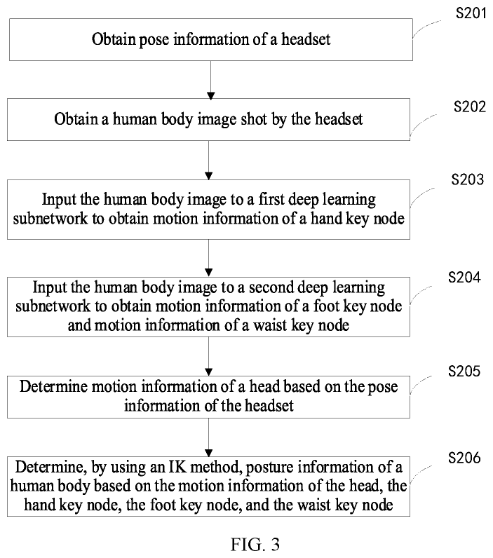

FIG. 3 is a schematic flowchart of the human body motion capture method according to Embodiment 2 of the present application. As shown in FIG. 3, the method provided in this embodiment includes the following steps.
S201: Obtain the pose information of the headset.
S202: Obtain the human body image shot by the headset.
S203: Input the human body image to the first deep learning subnetwork to obtain the motion information of the hand key node.
S204: Input the human body image to the second deep learning subnetwork to obtain the motion information of the foot key node and the motion information of the waist key node.
S205: Determine the motion information of the head based on the pose information of the headset.

There is no execution sequence between steps S202, S203, and S204, or they may be simultaneously performed in parallel.

The SLAM module is an existing module of the XR device. The pose information of the headset in the SLAM module may not only be used for the method in this embodiment but also have another use. It may be understood that in the method in this embodiment, the pose information of the headset is only read from the SALM module.

Optionally, in other embodiments of the present application, the third deep learning subnetwork may further be included. The human body image is input to the third deep learning subnetwork to obtain the motion information of the key node. In other words, the motion information of each key node is learned through a separate deep learning network.
S206: Determine, by using the IK method, the posture information of the human body based on the motion information of the head, the hand key node, the foot key node, and the waist key node.

In this embodiment of the present application, the deep learning network may be trained with a large number of human body sample images. A label of the human body sample image is actual motion information of the key node. The actual motion information of the key node includes actual position information or actual pose information of the key node. A deep learning network is trained with the human body sample image, and an output of the deep learning network is estimated motion information of the human body sample image. A loss of the deep learning network is computed based on the label of the human body sample image and the estimated motion information output by the deep learning network. The loss is used to represent a difference between the actual motion information and the estimated motion information of the human body sample image. A parameter of the deep learning network is updated based on the loss of the deep learning network. A plurality of rounds of iterative training may be performed on a training data set to obtain a final deep learning network. When an iteration end condition is satisfied, model training is ended, and a trained deep learning network is used as the final deep learning network. The iteration end condition may be that a loss value reaches a preset threshold or a loss value does not decrease for a plurality of consecutive rounds.

In a model training process, if the label of the human body sample image is actual position information of the key node, the output of the deep learning network is estimated position information of the key node; or if the label of the human body sample image is actual pose information of the key node, the output of the deep learning network is estimated pose information of the key node.

Optionally, the loss of the deep learning network is a mean squared error (MSE) loss, and the MSE loss is also referred to as an L2 loss. The loss may alternatively be a mean absolute error (MAE), and the MAE loss may also be referred to as an L1 loss. Certainly, the loss of the model may alternatively be computed by using another existing loss function. This is merely an example for description herein, and a loss function of the deep learning network is not defined in the embodiments of the present application.

Optionally, when the key node is visible in the human body sample image, the loss of the deep learning network is computed based on the label of the human body sample image and the estimated motion information output by the deep learning network; or when the key node is not visible in the human body sample image, the human body sample image is not considered for the loss, that is, the human body sample image is not used to compute the loss of the deep learning network.

Accordingly, before the loss of the deep learning network is computed, whether the key node is visible in the human body sample image needs to be determined. Optionally, a confidence of the key node is determined based on the human body sample image, and whether the key node is visible is determined based on the confidence of the key node. For example, a confidence threshold is set. If the confidence of the key node is greater than or equal to the confidence threshold, it is determined that the key node is visible in the human body sample image; or if the confidence of the key node is less than the confidence threshold, it is determined that the key node is not visible in the human body sample image. The confidence of the key node may be computed based on a heatmap of the human body sample image.

When the deep learning network includes the first deep learning subnetwork and the second deep learning subnetwork, the human body sample image and the label of the human body sample image are input to the deep learning network. The label of the human body sample image input to the first deep learning subnetwork is actual motion information of the hand key node. The label of the human body sample image input to the second deep learning subnetwork is actual motion information of the foot key node and the waist key node. The first deep learning subnetwork learns the human body sample image to obtain estimated motion information of the hand key node. A first loss of the first deep learning subnetwork is computed based on the actual motion information and the estimated motion information of the hand key node. The second deep learning subnetwork learns the human body sample image to obtain estimated motion information of the foot key node and the waist key node. A second loss of the second deep learning subnetwork is computed based on the actual motion information and the estimated motion information of the foot key node and the waist key node.

After the first loss and the second loss are computed, the loss of the entire deep learning network is obtained based on the first loss and the second loss. For example, weighted averaging is performed on the first loss and the second loss to obtain the loss of the deep learning network.

Similarly, when the deep learning network includes three subnetworks, losses of the three subnetworks are computed separately, and weighted averaging is performed on the losses of the three subnetworks to obtain the loss of the deep learning network.

In this embodiment, the human body image shot by the headset is obtained. The human body image is input to the first deep learning subnetwork to obtain the motion information of the hand key node. The human body image is input to the second deep learning subnetwork to obtain the motion information of the foot key node and the waist key node. The motion information of the head of the human body is determined based on the pose information of the headset obtained by the SLAM module through localization. The posture information of the human body is determined by using the IK method based on the motion information of the head, the hand key node, the foot key node, and the waist key node. In this method, the motion information of the hand key node, the foot key node, and the waist key node in the human body image is determined through the deep learning network, so that the motion information of the key node of the human body is computed more accurately. Therefore, accuracy of subsequent human posture estimation is improved.

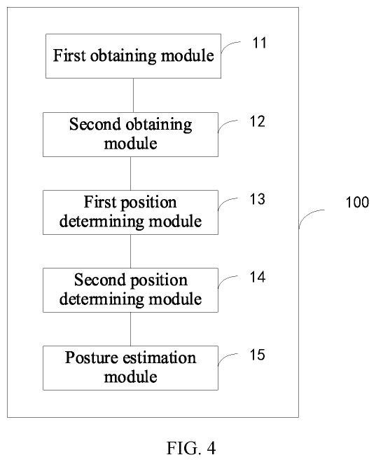

For case of better implementing the human body motion capture method in the embodiments of the present application, an embodiment of the present application further provides a human body motion capture apparatus. FIG. 4 is a schematic diagram of a structure of a human body motion capture apparatus according to Embodiment 3 of the present application. As shown in FIG. 4, the human body motion capture apparatus 100 may include:
a first obtaining module 11 configured to obtain pose information of a headset;
a second obtaining module 12 configured to obtain a human body image shot by the headset;
a first position determining module 13 configured to determine motion information of a key node of a human body based on the human body image, the motion information of the key node including position information or pose information of the key node, and the key node including one or more of a hand key node, a foot key node, or a waist key node;
a second position determining module 14 configured to determine motion information of a head based on the pose information of the headset, the motion information of the head including position information or pose information of the head; and
a posture estimation module 15 configured to determine, by using an inverse kinematics method, posture information of the human body based on the motion information of the key node and the motion information of the head.

In some embodiments, the first position determining module 13 is specifically configured to:
input the human body image to a deep learning network to obtain the motion information of the key node of the human body.

In some embodiments, the deep learning network includes a first deep learning subnetwork and a second deep learning subnetwork; and
the first position determining module 13 is specifically configured to:
input the human body image to the first deep learning subnetwork to obtain motion information of the hand key node; and
input the human body image to the second deep learning subnetwork to obtain motion information of the foot key node.

In some embodiments, the second deep learning subnetwork further outputs motion information of the waist key node.

In some embodiments, the deep learning network further includes a third deep learning subnetwork; and the first position determining module 13 is further configured to:
input the human body image to the third deep learning subnetwork to obtain motion information of the waist key node.

In some embodiments, when the motion information of the key node includes the position information of the key node, and the motion information of the head includes the position information of the head, the posture estimation module 15 is specifically configured to:
determine, by using the inverse kinematics method, posture information of the key node and posture information of the head based on the position information of the key node and the position information of the head; and
determine posture information of another node of the human body based on the posture information of the key node and the posture information of the head.

In some embodiments, the method further includes a training module configured to:
train the deep learning network with a human body sample image, a label of the human body sample image being actual motion information of the key node, and the actual motion information of the key node including actual position information or actual pose information of the key node;
compute a loss of the deep learning network based on the label of the human body sample image and estimated motion information output by the deep learning network; and
update a parameter of the deep learning network based on the loss of the deep learning network.

In some embodiments, the training module is specifically configured to:
when the key node is visible in the human body sample image, compute the loss of the deep learning network based on the label of the human body sample image and the estimated motion information output by the deep learning network.

In some embodiments, the training module is further configured to:
determine a confidence of the key node based on the human body sample image; and
determine, based on the confidence of the key node, whether the key node is visible.

In some embodiments, the motion information of the foot key node is motion information of an ankle of the human body, and/or the motion information of the hand key node is motion information of a wrist of the human body.

In some embodiments, the headset obtains the pose information of the headset by using a visual simultaneous localization and mapping (SLAM) method.

It should be understood that the apparatus embodiment may correspond to the method embodiment. For similar descriptions, reference may be made to the method embodiment. To avoid repetitions, details are not described herein again.

The apparatus 100 in this embodiment of the present application is described above with reference to the accompanying drawings from the perspective of a functional module. It should be understood that the functional module may be implemented in the form of hardware, or may be implemented by instructions in the form of software, or may be implemented by a combination of hardware and a software module. Specifically, the steps in the method embodiment in the embodiments of the present application may be completed by a hardware integrated logic circuit in a processor and/or the instructions in the form of the software. The steps of the method disclosed with reference to the embodiments of the present application may be directly embodied to be completed by a hardware decoding processor or by a combination of hardware in the decoding processor and a software module. Optionally, the software module may be located in a mature storage medium in the art, such as a random access memory, a flash memory, a read-only memory, a programmable read-only memory, an electrically erasable programmable memory, or a register. The storage medium is located in a memory. The processor reads information in the memory, and completes the steps in the foregoing method embodiment in combination with the hardware of the processor.

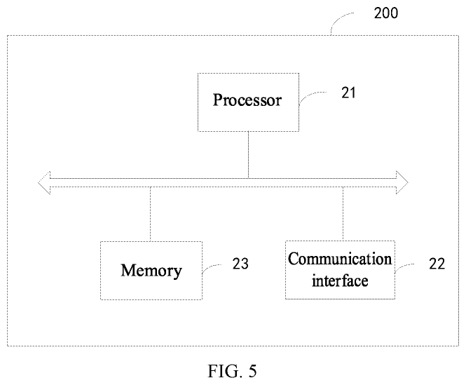

An embodiment of the present application further provides an electronic device. FIG. 5 is a schematic diagram of a structure of an electronic device according to Embodiment 4 of the present application. As shown in FIG. 5, the electronic device 200 may include:
a memory 21 and a processor 22, where the memory 21 is configured to store a computer program, and transmit the program code to the processor 22. In other words, the processor 22 may invoke, from the memory 21, and run the computer program to implement the method in the embodiments of the present application.

For example, the processor 22 may be configured to perform the foregoing method embodiment according to instructions in the computer program.

In some embodiments of the present application, the processor 22 may include but is not limited to:
a general-purpose processor, a digital signal processor (DSP), an application specific integrated circuit (ASIC), a field programmable gate array (FPGA) or another programmable logic device, a discrete gate or transistor logic device, a discrete hardware component, and the like.

In some embodiments of the present application, the memory 21 includes but is not limited to:
a volatile memory or a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), which is used as an external cache. By way of example but not restrictive description, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synch link dynamic random access memory (SLDRAM), and a direct rambus random access memory (DR RAM).

In some embodiments of the present application, the computer program may be divided into one or more program modules, and the one or more program modules are stored in the memory 21 and executed by the processor 22, to implement the method provided in the present application. The one or more modules may be a series of computer program instruction segments capable of implementing specific functions. The instruction segments are used to describe an execution process of the computer program in the electronic device.

As shown in FIG. 5, the electronic device 200 may further include a transceiver 23. The transceiver 23 may be connected to the processor 22 or the memory 21.

The processor 22 may control the transceiver 23 to communicate with another device, specifically to send information or data to the another device or to receive information or data sent by the another device. The transceiver 23 may include a transmitter and a receiver. The transceiver 23 may further include an antenna. There may be one or more antennae.

It may be understood that the electronic device 200 may further include a camera module, a wireless fidelity (Wi-Fi) module, a localization module, a Bluetooth module, a display, a controller, and the like that are not shown in FIG. 5. Details are not described herein again.

It should be understood that the components of the electronic device are connected to each other through a bus system. In addition to a data bus, the bus system further includes a power bus, a control bus, and a status signal bus.

The present application further provides a computer storage medium storing a computer program that, when executed by a computer, causes the computer to perform the method in the foregoing method embodiment. Alternatively, an embodiment of the present application further provides a computer program product including instructions that, when executed by a computer, cause the computer to perform the method in the foregoing method embodiment.

The present application further provides a computer program product. The computer program product includes a computer program. The computer program is stored in a computer-readable storage medium. A processor of an electronic device reads the computer program from the computer-readable storage medium. The processor executes the computer program, so that the electronic device performs the corresponding process in the human body motion capture method in the embodiments of the present application. For brevity, details are not described herein again.

In the several embodiments provided in the present application, it should be understood that the disclosed system, apparatus, and method may be implemented in other manners. For example, the described apparatus embodiment is merely an example. For example, the module division is merely logical function division and may be other division during actual implementation. For example, a plurality of modules or components may be combined or integrated into another system, or some features may be ignored or not performed. In addition, the displayed or discussed mutual couplings, direct couplings, or communication connections may be implemented through some interfaces. The indirect couplings or communication connections between the apparatuses or modules may be implemented in electrical, mechanical, or other forms.

The modules described as separate parts may or may not be physically separate, and parts displayed as modules may or may not be physical modules, and may be located at one position, or may be distributed on a plurality of network units. Some or all of the modules may be selected based on an actual requirement to achieve the objective of the solution of this embodiment. For example, functional modules in the embodiments of the present application may be integrated into one processing module, each of the modules may exist alone physically, or two or more modules may be integrated into one module.

The foregoing descriptions are merely specific implementations of the present application, but are not intended to limit the scope of protection of the present application. Any variation or replacement readily figured out by a person skilled in the art within the technical scope disclosed in the present application shall fall within the scope of protection of the present application. Therefore, the scope of protection of the present application shall be subject to the scope of protection of the claims.

1. A human body motion capture method, comprising:
obtaining pose information of a headset;
obtaining a human body image shot by the headset;
determining motion information of a key node of a human body based on the human body image, the motion information of the key node comprising position information or pose information of the key node, and the key node comprising one or more of a hand key node, a foot key node, or a waist key node;
determining motion information of a head based on the pose information of the headset, the motion information of the head comprising position information or pose information of the head; and
determining, by using an inverse kinematics method, posture information of the human body based on the motion information of the key node and the motion information of the head.

2. The method according to claim 1, wherein the determining motion information of a key node of a human body based on the human body image comprises:
inputting the human body image to a deep learning network to obtain the motion information of the key node of the human body.

3. The method according to claim 2, wherein the deep learning network comprises a first deep learning subnetwork and a second deep learning subnetwork; and
the inputting the human body image to a deep learning network to obtain the motion information of the key node of the human body comprises:
inputting the human body image to the first deep learning subnetwork to obtain motion information of the hand key node; and
inputting the human body image to the second deep learning subnetwork to obtain motion information of the foot key node.

4. The method according to claim 3, wherein the second deep learning subnetwork further outputs motion information of the waist key node.

5. The method according to claim 3, wherein the deep learning network further comprises a third deep learning subnetwork, and the method further comprises:
inputting the human body image to the third deep learning subnetwork to obtain motion information of the waist key node.

6. The method according to claim 1, wherein when the motion information of the key node comprises the position information of the key node, and the motion information of the head comprises the position information of the head, the determining, by using an inverse kinematics method, posture information of the human body based on the motion information of the key node and the motion information of the head comprises:
determining, by using the inverse kinematics method, posture information of the key node and posture information of the head based on the position information of the key node and the position information of the head; and
determining posture information of another node of the human body based on the posture information of the key node and the posture information of the head.

7. The method according to claim 2, wherein when the motion information of the key node comprises the position information of the key node, and the motion information of the head comprises the position information of the head, the determining, by using an inverse kinematics method, posture information of the human body based on the motion information of the key node and the motion information of the head comprises:
determining, by using the inverse kinematics method, posture information of the key node and posture information of the head based on the position information of the key node and the position information of the head; and
determining posture information of another node of the human body based on the posture information of the key node and the posture information of the head.

8. The method according to claim 3, wherein when the motion information of the key node comprises the position information of the key node, and the motion information of the head comprises the position information of the head, the determining, by using an inverse kinematics method, posture information of the human body based on the motion information of the key node and the motion information of the head comprises:
determining, by using the inverse kinematics method, posture information of the key node and posture information of the head based on the position information of the key node and the position information of the head; and
determining posture information of another node of the human body based on the posture information of the key node and the posture information of the head.

9. The method according to claim 4, wherein when the motion information of the key node comprises the position information of the key node, and the motion information of the head comprises the position information of the head, the determining, by using an inverse kinematics method, posture information of the human body based on the motion information of the key node and the motion information of the head comprises:
determining, by using the inverse kinematics method, posture information of the key node and posture information of the head based on the position information of the key node and the position information of the head; and
determining posture information of another node of the human body based on the posture information of the key node and the posture information of the head.

10. The method according to claim 5, wherein when the motion information of the key node comprises the position information of the key node, and the motion information of the head comprises the position information of the head, the determining, by using an inverse kinematics method, posture information of the human body based on the motion information of the key node and the motion information of the head comprises:
determining, by using the inverse kinematics method, posture information of the key node and posture information of the head based on the position information of the key node and the position information of the head; and
determining posture information of another node of the human body based on the posture information of the key node and the posture information of the head.

11. The method according to claim 2, further comprising:
training the deep learning network with a human body sample image, a label of the human body sample image being actual motion information of the key node, and the actual motion information of the key node comprising actual position information or actual pose information of the key node;
computing a loss of the deep learning network based on the label of the human body sample image and estimated motion information output by the deep learning network; and
updating a parameter of the deep learning network based on the loss of the deep learning network.

12. The method according to claim 11, wherein the computing a loss of the deep learning network based on the label of the human body sample image and estimated position information output by the deep learning network comprises:
when the key node is visible in the human body sample image, computing the loss of the deep learning network based on the label of the human body sample image and the estimated motion information output by the deep learning network.

13. The method according to claim 12, further comprising:
determining a confidence of the key node based on the human body sample image; and
determining, based on the confidence of the key node, whether the key node is visible.

14. The method according to claim 1, wherein the motion information of the foot key node is motion information of an ankle of the human body, and/or the motion information of the hand key node is motion information of a wrist of the human body.

15. The method according to claim 2, wherein the motion information of the foot key node is motion information of an ankle of the human body, and/or the motion information of the hand key node is motion information of a wrist of the human body.

16. The method according to claim 1, wherein the headset obtains the pose information of the headset by using a visual simultaneous localization and mapping (SLAM) method.

17. The method according to claim 2, wherein the headset obtains the pose information of the headset by using a visual simultaneous localization and mapping (SLAM) method.

18. A human body motion capture apparatus, comprising:
a first obtaining module configured to obtain pose information of a headset;
a second obtaining module configured to obtain a human body image shot by the headset;
a first position determining module configured to determine motion information of a key node of a human body based on the human body image, the motion information of the key node comprising position information or pose information of the key node, and the key node comprising one or more of a hand key node, a foot key node, or a waist key node;
a second position determining module configured to determine motion information of a head based on the pose information of the headset, the motion information of the head comprising position information or pose information of the head; and
a posture estimation module configured to determine, by using an inverse kinematics method, posture information of the human body based on the motion information of the key node and the motion information of the head.

19. An electronic device, comprising:
a processor and a memory, wherein the memory is configured to store a computer program, and the processor is configured to invoke and run the computer program stored in the memory, to perform:
obtaining pose information of a headset;
obtaining a human body image shot by the headset;
determining motion information of a key node of a human body based on the human body image, the motion information of the key node comprising position information or pose information of the key node, and the key node comprising one or more of a hand key node, a foot key node, or a waist key node;
determining motion information of a head based on the pose information of the headset, the motion information of the head comprising position information or pose information of the head; and
determining, by using an inverse kinematics method, posture information of the human body based on the motion information of the key node and the motion information of the head.

20. A computer-readable storage medium, configured to store a computer program, wherein the computer program causes a computer to perform the method according to claim 1.
